(19) United States
(12) Patent Application Publication
(10) Pub. No.: US 2005/0105871 A1
(43) Pub. Date: May 19, 2005

(54) Method for the separation of optical fibers by means of co2 laser radiation

(76) Inventors: Gisbert Staupendahl, Kunitz (DE); Jurgen Weisser, Jena (DE); Gabriele Eberhardt, Jena (DE); Norbert Preuss, Jena (DE)

Correspondence Address: Patent Administrator;Testa Hurwitz & Thibeault, 125 High Street, High Street Tower, Boston, MA, 02110, US

(21) Appl. No.: 10/500,090

(22) PCT Filed: Dec. 17, 2002
(86) PCT No.: PCT/DE02/04693

(30) Foreign Application Priority Data
Dec. 28, 2001 (EP) 101 64 579.1

(51) Int. Cl. G02B 6/00

(52) U.S. Cl. 385/134

(57) ABSTRACT

Disclosed is a method for separating optical fibers by means of CO₂ laser radiation, appllicable with various types and sizes of fibers with or without cladding as well as with fiber bunches and fiber components. According to the inventive method, separation is performed by means of a special impulse regime adapted to each material, whereby minuscule volumes of material are removed along a line in a sawing-like process until complete separation has been achieved.

The invention concerns a method for the separation of optical fibers by CO₂ laser radiation. The invented method can be used over a broad palette of optical fibers, which can be varied from monomode, multimode up to gradient fibers with a great difference in predetermined diameters to suit specific applications. Even unclad fibers can be separated by this method. This method is especially adaptable for the custom treatment of fiber end surfaces in plug-in or special end surfaces for connection to electro-optical transducers of individual glass fibers and fiber bundles. The method excels in great flexibility, high quality of separated surfaces and requiring small rework time for its finished, separated fibers. The method also has high operational speed and contributes to the possibility of automatizing the separation process.

With the current world wide use of broad band data transmission by means of light-conducting fibers, the necessity of an efficient fabrication of these fibers extends itself into the most different kinds of application areas. A basic problem is inherent in fiber separation, i.e., “cutting” in order to achieve a high degree of planar uniformity at the protruding end surfaces, which surfaces must bring about low damping connections of the fibers in optical and optoelectronic instruments.

In contradistinction to the presently invented, advanced method for the manufacture and application of light-conducting fibers, the heretofore state of the technology for fiber separation can be regarded as practically obsolete.

Now, as in the past, the conventional method of the separation of fibers is purely a manual operation. For example, separation equipment was used on the basis of scratching the fibers by means of a diamond point. The typical method of operation is such, that the unclad fibers are laid in a large guide groove. The exact determination of the fiber end lengths, is enabled by an adjustable tool or by means of scaling. Upon closing the tool, the fibers become fixed in place and prestressed. Subsequently, a diamond blade makes a surface incision in the fiber. The fiber then breaks at right angles to the axis of the fiber, more exactly, the break will deviate about 8° from a right angle. In the case of circumferentially clad fibers, a removal of the cladding is necessary before cutting.

Functioning in a more simple fashion are diamond fiber cutting tools (cleaving knives) in a ball point format, wherein, the separation (breaking) is carried out with the optical fibers by a light scratching of the fiber surface, (i.e., scratching the core, where fibers with plastic cladding are involved, or scratching the cladding in the case of quartz or quartz fibers). By pulling the fiber, the fiber axis zone, so treated, is subjected to an axial force at the weakened scratch position, whereupon, the fiber breaks at that point.

The said conventional methods are only adaptable for individual fibers and can only be optimized for given individual fibers. If the conventional method proves inoperable for the separation of fiber bundles, then the very crude method of “hacking” is put to use. “Hacking” causes, naturally, extremely distorted separation surfaces, with resulting high costs in money and time for polishing.

All mechanical methods have in common a series of grave disadvantages. The result is, that mechanical separating methods cannot be automatized. The mechanical methods are not very flexible and acceptable results can only be achieved for special forms of fibers and custom made fibrous products. Typical for the cut surfaces are faults such as spalling, protruding glass splinter and microfissures, so that considerable expenditure of work and expense must be lost in rework.

The CO₂ laser appears to be particularly well suited for separation. The radiation recommends itself by being highly absorbed by all types of glass common in light-conducting fibers, and in addition, also absorbed by plastics. The plastics would be found in the said cladding.

An uncounted number of methods for the separation of friable materials, notably, of glass, by means of a laser are known in the present technology. In most cases, a CO₂ laser would be chosen as the radiation source.

Fundamentally, these methods differentiate themselves, into first, those methods wherein the material along the desired line of separation is heated, and heated up to the transformation temperature, that is, the softening temperature, (also known as melting cutting). Second, other methods induce thermal stress by means of a laser, wherein, spontaneously, or even after the said scratching, a break occurs along the desired line of separation. Where the said melting cutting is concerned, reference can be made to EP 0 062 484. Methods, wherein the glass separates due to the production of breaking stress is concerned, are to be found described in DE 28 13 302, DE 43 05 107, U.S. Pat. No. 3,543,979 and U.S. Pat. No. 5,084,604. In particular, in this stress breaking method, the improvement of the quality of the separated surface is the purpose of the cited inventions.

As it has developed however, from practical investigations, neither the melting procedure nor the separation by thermal stress breaking adapt well to separation of light-conducting fibers having intersections showing required quality at the cut fiber surfaces.

Thus, it is the purpose of the invention, to make available a method, wherein the separation of light-conducting fibers of the most different kinds, such as monomode fibers or multimode fibers, gradient fibers, or glass and plastic fibers, either singly or as fiber bundles, with or without cladding, is carried out with the greatest possible precision of the positioning of the separated surfaces and makes possible a high quality of the said separated surfaces. The invented method is to be adaptable to produce separating surfaces at either right angles to or at selected angles to the fiber core. The necessary rework of the separation surface should be minimal or even be eliminated entirely. The method should be completely adaptable to automatization. This purpose is achieved as a method for the separation of light-conducting fibers by means of CO₂ laser beam radiation in accord with the principal concept of claim 1. This is accomplished, in that, originating from the CO₂ laser radiation, in accord with the invention, an operational beam 8, comprised of individual pulses with the radiation parameter-impulse of characteristics:
pulse peak loading \hat{P}, some W≦\hat{P+EE≦1 kW,}
pulse-half-intensity beam width τᵢₘₚ, 10⁻⁵ s≦τᵢₘₚ≦10⁻⁴ s
and pulse repetitive frequency fᵢₘₚ, 100 Hz≦fᵢₘₚ≦NkHz
where N=a plurality of kHz. and the said operational beam 8 is disengaged. Further the operational beam 8 is focused on a light-conducting fiber which is fixed in place and beam 8 is caused to move back and forth in a plane along a specified working line, so that, per pulse, an elementary volume is removed, which approaches, in a mathematical sense, the equal of the product of optical penetration depth d times the cross-section of the beam which has a diameter approximately equal to the focused diameter, in any case, smaller than twice that, until the light-conducting fiber is fully cut through.

It is within this concept of the invention, that the separation process is to be carried out independently of the specific composition of the individual fiber to be separated, or, if not of an individual fiber, then of a fiber bundle (this being hereinafter the “object”). This independency is counter to what is known in the state of the technology, i.e., as separation “in one stroke”, which would be carried out by intensive radiation of a CO₂ laser. Rather, in the invented method, the procedure is by a special pulse regime suited to the material at hand, carried out in an extremely protective manner to the advantage of the fiber. Pulse for pulse, the smallest possible increment of fiber material is removed along a line until, by this “sawlike process” the entire separation is achieved. That is to say, the entire cut of the separation composes itself from the total of a multitude of individual separation cuts. The magnitude of the removed material volumes (hereinafter each incremental volume is termed an “elementary volume”), is determined by the product of the beam cross-section surface in the operational plane times the depth of penetration into the material. In order to hold the beam cross-section surface as small as possible, the laser beam is advantageously focused on the surface of the as-yet-untreated object, and shaped in such a manner, that the Raleigh length is greater than the total diameter of the object.

In this way, the peak loading of the pulse and the duration thereof (and hence the pulse energy) is so selected, that exactly one elementary volume is removed per pulse (essentially vaporized). In this case, the matter at hand is an absorption controlled removal, wherein the evolved increment of the melted material is reduced, and therewith the tendency to microfissures is minimized.

In order to be able to separate light-conducting fibers with the invented method, in cases where the target diameter is less than 0.1 mm, necessity calls for a very large number of individual pulses. Again, in order to come to a reasonable rate of working, on this account, the repetition frequency should be great, typically lying in the magnitude of some kHz. So that this situation does not eliminate the most favorable action of the elementary removal, such a rapid movement of the focused laser beam by the probe becomes necessary, that the pulses hit with a certain degree of overlapping each other. Thereby the elementary volume itself is removed in an overlapping manner. Advantageously, the overlapping runs about 70%. Upon a sweep of the beam over the individual fiber or fiber bundle, there is created a deepness of cut, which does not greatly overstep the penetration depth of beam penetration into the fiber material. This overstep of cut is estimated at about 10 μm.

The entire separating cut is reached by a corresponding number of over-runs of the beam traversing the individual fiber/fiber bundle (for a single separating cut).

The time based duration between the production of the individual separating cut should be chosen to be so large, that a sufficient cooling of the last worked zone can occur. This serves the goal, of producing no greater melted portions by unreliable summing of applied radiation power. Advantageously, a cooling time runs approximately in the range of 10⁻² to 10⁻¹ seconds.

Expanding the reference to the method as “a sawlike process” then, correspondingly, the teeth of the imaginary saw are represented by beam pulses and the back and forth movement of the “saw”, represents the back and forth motion of the beam over the individual fibers or fiber bundle.

The invented method allows, not only to cut transversely to the axis of the fiber, but also to open up a wider cutting angle for the positioning of the separating line to the fiber axes. In this way, the making of the entire separating cut by means of a multiplicity of individual cuts, acts advantageously on the precision of a desired angle, since the design of the resulting cut surface is influenced only in small measure by the surface tension of the melted portions which are formed by the on going separating process.

An additional advantage of the invented method, rests on the fact, that all components of the fiber configuration which are in question, including the different kinds of glass, the plastics for cladding, or even the adhesive, absorb CO₂ laser radiation in a similar manner, so that all of these components can be separated with an optimized pulse regime, although the optimization, obviously, is principally concentrated on the fiber core and the fiber cladding.

In the following, the invention will be more closely described and explained with the aid of a drawing of one embodiment., There is shown in:

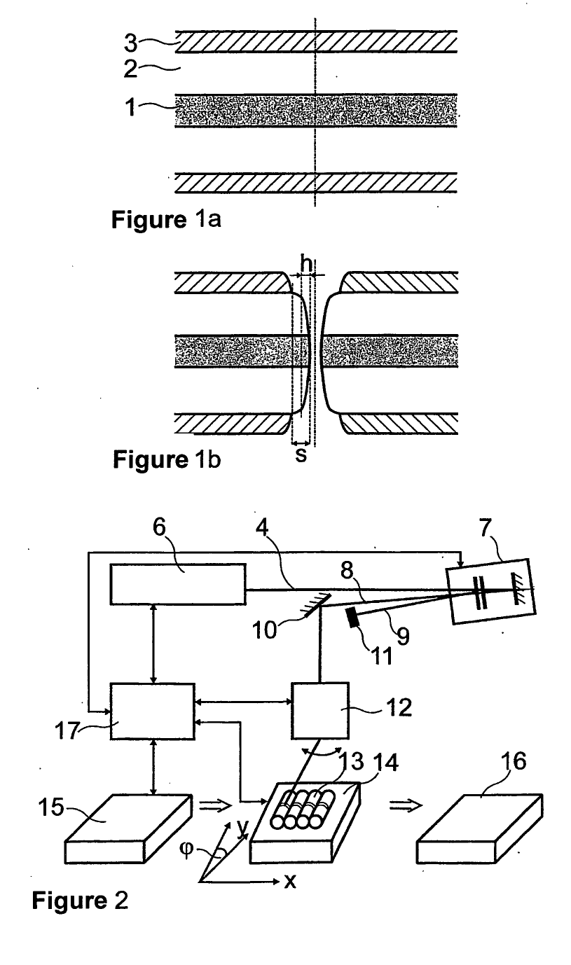

FIG. 1a construction of an unclad optical fiber before separation,

FIG. 1b the unclad fiber after the separation,

FIG. 2 basic construction of an apparatus for the execution of the method,

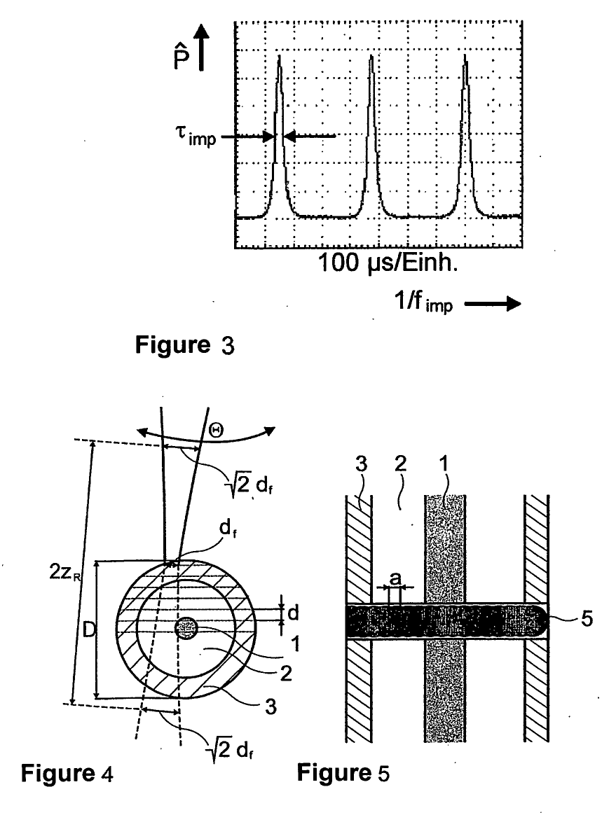

FIG. 3 typical frequency of pulse peaks of the occurring radiation,

FIG. 4 instructive drawing for the operation of the method,

FIG. 5 top view of the kerf, overlap of single impulse,

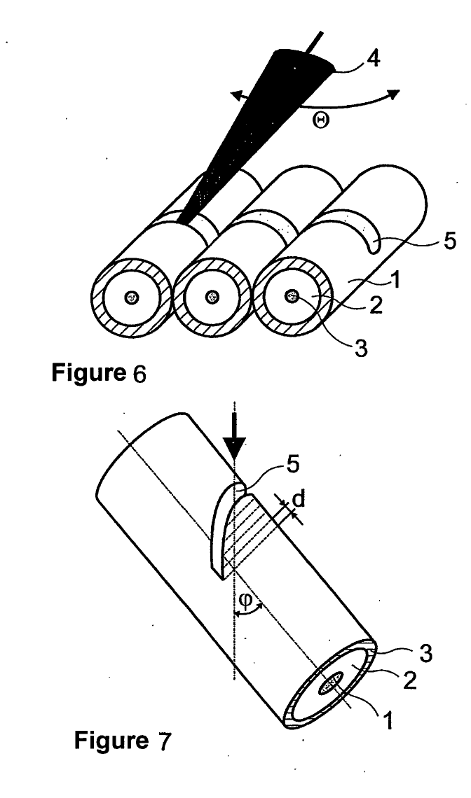

FIG. 6 instructive drawing for explanation of the method on a fiber bundle, and

FIG. 7 instructive drawing for the explanation of the method on a single fiber at a defined angle to the fiber axis.

Considering first the FIGS. 1a, 1b, the fundamental problem upon the separation of an unclad individual fiber by means of laser radiation is shown.

The principal difficulties exist, first, in the demanded high precision of the cut, and second in the fact that the workpiece, which comprises a fiber core 1, a fiber coating 2 and a protective layer 3, thus consisting of three different light-conducting media, is to be separated with one beam of unchanged radiation parameters.

The result of this is, that the protective layer 3, which, in general always consists of a plastic, because of the essentially lesser removal threshold as compared to the fiber core 1 and the fiber coating 2, is subjected to removal from an essentially greater area, that is, after the separating procedure, the protective shell 3 is retracted from the fiber end by about a step of length “s”.

Moreover, the separating surface over the fiber core 1 and the fiber coating 2 is never ideally even, but a certain rounding off has taken place which shows a central camber protrusion of “h”. In order, when considering how to attain the most even separating surface on the fiber composition, the camber height must be held as small as possible, so that rework can be either completely avoided, or the amount of such rework becomes negligible. The decisive point for this is, that the stepwise separation, by the removal of incremental elementary volumes is done with an optimized pulse regime on the respective work piece material.

For the explanation of the method, in FIG. 2 is presented a typical layout for an apparatus for the carrying out of the method. Thus, FIG. 2 shows a CO₂ laser 6, a modulator 7, a beam receiver 11, a beam diverter 12, an adjustable restraining unit 14 and a central control 17.

The generally continuous radiation 4 of the CO₂ laser 6 is divided into two beam parts by means of the modulator 7, which operates in the regime of “double transmission”. The two so divided beams are, namely, an operative beam 8 and a residual beam 9 (see DE 40 4 744 C2). In this way, from the laser beam 4, periodic pulses are disengaged, the parameters thereof are widely varied, and the respective separation process can be optimally adjusted. The residual beam 9 is captured by a beam receiver 11, whereby, this being either an absorber, which destroys the beam, or is a measuring apparatus with which, for example, the continuity of beam power online can be monitored.

By means of a beam guidance director 10, symbolized by a mirror, the operational beam 8 is diverted into a beam diverter 12. This can advantageously be a scanner with an integrated focusing apparatus (for example, with a F-Θ-Lens) which can cope with the necessarily rapid movement of the focused operative beam 8 about an angle Θ over the to-be-separated object 13. In the case of this object 13, this can be an individual light-conducting fiber, with or without cladding, it may be a bundle of light-conducting fibers, again with or without cladding or even contain fiber components.

The object 13 is affixed on an adjustable holding stand 14 which, first, has a precise x-y positioning, for example, permitting setting within an exactitude range of 0.01 mm of the object. Second, the adjustment of a defined angle φ between the fiber axis and the plane of the incident beam is made possible, and hence a precise inclined cut.

Finally, this basic flow layout is amplified by a feed apparatus 15 and a removal means 16, so that the entire process can be made to operate automatically. The central control unit 17 takes care of the time related control of all relevant components.

A central point in the method, accepts the correct selection of the pulse parameters of the operational beam 8. FIG. 3 illustrates a frequency of characteristic pulse peaks, which are generated in modulator 7 and are used as operative beam 8 for the separation process. The relevant parameters of the pulse frequency—i.e., pulse peak power \hat{P}, pulse half-value τᵢₘₚ, and impulse repetitive frequency fᵢₘₚ can be varied by means of the adjustable modulator technology within wide ranges, and thus optimized for the separation of a particular object.

Typical parameter ranges are:
\hat{P}=some W≦\hat{P}≦1 kW,
Pulse half value=10⁻⁵≦τᵢₘₚ≦10⁻⁴ sec
Pulse repetitive frequency=100 Hz≦fᵢₘₚ≦a plurality of kHz

The pulse parameters, dependent upon the material parameters of the to-be-treated-object, are so chosen, that the radiation power absorbed by the object per pulse heats a thin surface layer of a few μm (optical penetration depth d) up to its vaporization temperature. Accompanying the vaporization in the edge area of the vaporization zone, the melt-particles, which are created thereby, are also expelled. The removal of the material vapor and the said melt-particles can be supported by blowing on the sample with an operational gas, for instance, this can be cleaned, compressed air at about 1 bar working pressure, which is particularly appropriate for cleaning glass fibers.

The expulsion per pulse places the presently defined elementary volumes to very closely approach equality to the product of optical penetration depth d times the incident beam cross-section.

The method should, with the aid of the FIGS. 4, 5, be explained for the separation of an individual fiber. In accord with FIG. 4, the modulated operational beam 8, which is focused on the surface of the still non-treated individual fiber, is moved over the individual fiber, while the said beam 8 is swung back and forth within the limits of the angle Θ. At each overpass, material is removed at nearly the optical penetration depth d, i.e., approximately of the magnitude of 10⁻⁵ m. In the following, this will be named the “partial cut”.

In order that the individual partial cuts may have wide ranging focusing conditions, then the Rayleigh length Z_{R} of the focused beam—this characterizes the area of the beam caustic, in which the intensity varies about a maximum factor of 2—should be greater than the total diameter D of the fiber. In this way, assurance is provided, that the beam diameter in the current operational plane is always less than twice the focusing diameter.

FIG. 5 shows, in a top view on the kerf, approximately in the stadium of the separation method, which the penetrative separation of the half fiber cross-section represents. As a further relevant method parameter, here the separative distance a of neighboring elementary volume is shown, as well as the overlapping of the individual pulses, which, in a typical example, would run some 78%.

A further embodiment example is schematically presented in FIG. 6—the through cut of a fiber bundle, wherein the bundle consists of three single fibers. In this case, what is valid for the design of the kerf 5, just mentioned above, in regard to the discussion on individual fibers, is also analogous for FIG. 6.

Particularly high demands on the method are placed by the separation of individual fibers and fiber bundles under the designed angle (p between the fiber axis and the plane of the separation. The geometric relationships for this case are seen in FIG. 7.

### REFERENCE NUMBERS AND CORRESPONDING COMPONENTS

Reference Numbers
and
Corresponding Components

| | |
|---|---|
| 1 | Core of light-conducting fiber |
| 2 | Coating on outside of fiber core |
| 3 | Protective cover of fiber |
| 4 | Beam of laser |
| 5 | Kerf of cut, i.e., separation clearance |
| 6 | CO₂ laser |
| 7 | Modulator |
| 8 | Operative laser beam |
| 9 | Remaining part of beam |
| 10 | Guidance for beam |
| 11 | Beam receiver |
| 12 | Beam diverter |
| 13 | Object (to be cut) |
| 14 | Adjustable precision holding means |
| 15 | Feed apparatus |
| 16 | Outlet apparatus |
| 17 | Central control unit |
| s | A retraction of shell 3 |
| h | Extension of end camber |
| \hat{P} | Pulse power peak |
| τᵢₘₚ | Pulse half value breadth |
| fᵢₘₚ | Pulse repeat frequency |
| d | Optical penetration |
| z_{R} | Rayleigh length |
| D | Total diameter |
| d_{f} | Focus diameter |

1. A method for the separation of light-conducting fibers by means of CO₂ laser radiation, comprising the steps of:
selecting from CO₂ laser radiation a disengaged operative beam comprising—individual pulses with beam parameters as follows:
Pulse peak power (\hat{P})=some W≦\hat{P}≦1 kW,
Pulse half value (τᵢₘₚ)=10⁻⁵≦τᵢₘₚ≦10⁻⁴ sec
Pulse repetitive frequncy (fᵢₘₚ)=100 Hz≦fᵢₘₚ≦a plurality of kHz;
focusing the operative beam on a fixed light-conducting fiber; and
moving the operative beam back and forth in a plane along a working zone, so that per pulse, one elementary volume, which is approximately equal to a product of optical penetration depth (d) times incident beam cross-section, with a diameter somewhat equal to that of the focus (d_{f}), but in any case, smaller than 2 (d_{f}), is removed, until the light-conducting fiber is completely cut through.

2. The method of claim 1, wherein between the individual back and forth movements over the light-conducting fiber, a cooling off phase from about 10 ms to about 100 ms is created, to assure a sufficient cooling of the working zone.

3. The method of claim 1, wherein the beam parameters, are adjustable during operation to fit different characteristics of raw material comprising the light-conducting fiber.

4. The method of claim 1, wherein the light-conducting individual fibers comprise different shapes and thicknesses.

5. The method of claim 1, wherein the light-conducting fiber comprises at least one of fiber bundles and fiber components.

6. The method of claim 1, wherein the elementary volume is smaller than 10⁻³ as compared to a total volume removed upon complete separation, and optical penetration depth (d) made at a single overrun of the bundle by the probe is small as compared to the diameter of the fiber's core.

7. The method of claim 1, wherein the working zone is blown with an operational gas to eject the evolved material vapors from the working zone.

8. The method of claim 4, wherein the light conducting fibers are selected from a group consiting of mono-mode, multi-mode, gradient, unclad, and clad fibers.

9. The method of claim 7, wherein the operational gas consists of purified compressed air at about 1 bar working pressure.
